(19) United States
(12) Patent Application Publication
(10) Pub. No.: US 2020/0342476 A1
(43) Pub. Date: Oct. 29, 2020

(54) SYSTEM FOR COST COMPARISONS WITHIN ITEM SIMILARITY CLUSTERS

(71) Applicant: Walmart Apollo, LLC, Bentonville, AR (US)

(72) Inventors: Mani Kanteswara Garlapati, Bangalore (IN); Souradip Chakraborty, Bengaluru (IN); Lakshmi Kommuru, Bangalore (IN)

(21) Appl. No.: 16/449,188

(22) Filed: Jun. 21, 2019

(30) Foreign Application Priority Data
Apr. 25, 2019 (IN) 201941016369

(51) Int. Cl. G06Q 30/02; G06Q 30/06

(52) U.S. Cl. CPC G06Q 30/0206; G06Q 30/0631

(57) ABSTRACT

Examples provide a system for performing retail-based cost reverse engineering and cost comparison within item similarity clusters for cost negotiations associated with a plurality of items. A cost manager component creates item similarity clusters based on item descriptions and cost trends associated with items over time. The cost manager component identifies items for action recommendations based on quantity and margin for each item. The recommendations can include a recommended set of item suitable for negotiations, promotional activities and/or a set of substitute items recommended for replacement of a selected item in an item assortment.

### BACKGROUND

A retail store frequently stocks thousands of different types of products. Each type of product may likewise have numerous different varieties, sizes and brands available for purchase. For example, ketchup can be available in multiple different sizes and different varieties such as, but not limited to, sugar free, spicy, organic, etc. Some product brands, varieties and product sizes may be more popular than other brands depending on a variety of factors, such as geographic region, promotions, seasonality, holidays and other factors. Likewise, customers at one store may prefer one variety type while customers at another store in a different location may prefer a completely different variety of the same product due to regional differences. Planning store assortments and selecting suppliers for these products can be a difficult, time-consuming and inefficient process.

### SUMMARY

Some examples provide a system for performing retail-based cost reverse engineering and cost comparisons within item similarity clusters for cost negotiations. The system analyzes retail price changes for an item over time and cost trends of the item over time. Cost comparisons for items are performed in item similarity clusters to identify negotiable items and/or item substitutes.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is an exemplary block diagram illustrating a system for performing cost comparisons of items within item similarity clusters.

FIG. 2 is an exemplary block diagram illustrating a cost manager component.

FIG. 3 is an exemplary block diagram illustrating a set of item similarity clusters.

FIG. 4 is an exemplary block diagram illustrating flow for computing similar cluster items.

FIG. 5 is an exemplary flow chart illustrating operation of the computing device to identify negotiable items and item substitutes.

FIG. 6 is an exemplary graph illustrating promotional breakdown of retail item price.

FIG. 7 is an exemplary graph illustrating trend-based analysis of average unit cost (AUC) and average unit retail (AUR).

FIG. 8 is an exemplary graph illustrating price gap versus margin.

FIG. 9 is an exemplary table illustrating quantity and margin item groups.

FIG. 10 is an exemplary table illustrating item margin percentage.

FIG. 11 is an exemplary table illustrating per-cluster item groupings.

FIG. 12 is an exemplary table illustrating a set of recommended actions based on per-item cost trends.

FIG. 13 is an exemplary bar graph illustrating quantity and margin values for an item.

Corresponding reference characters indicate corresponding parts throughout the drawings.

### DETAILED DESCRIPTION

A more detailed understanding can be obtained from the following description, presented by way of example, in conjunction with the accompanying drawings. The entities, connections, arrangements, and the like that are depicted in, and in connection with the various figures, are presented by way of example and not by way of limitation. As such, any and all statements or other indications as to what a particular figure depicts, what a particular element or entity in a particular figure is or has, and any and all similar statements, that can in isolation and out of context be read as absolute and therefore limiting, can only properly be read as being constructively preceded by a clause such as ‘In at least some examples, . . . _ For brevity and clarity of presentation, this implied leading clause is not repeated ad nauseum.

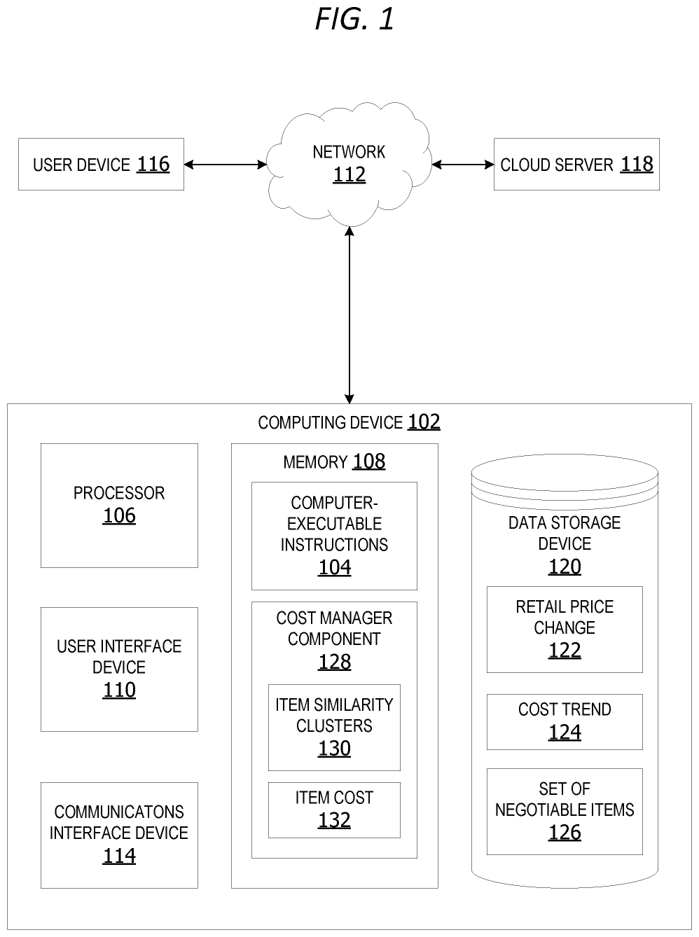

Referring to the figures, examples of the disclosure enable retail-based cost reverse engineering and cost comparison within item similarity clusters for cost negotiations and item substitute identification. Referring again to FIG. 1, an exemplary block diagram illustrates a system 100 for performing cost comparisons of items within item similarity clusters. In the example of FIG. 1, the computing device 102 represents any device executing computer-executable instructions 104 (e.g., as application programs, operating system functionality, or both) to implement the operations and functionality associated with the computing device 102. The computing device 102 in some examples includes a mobile computing device or any other portable device. A mobile computing device includes, for example but without limitation, a mobile telephone, laptop, tablet, computing pad, netbook, gaming device, and/or portable media player. The computing device 102 can also include less-portable devices such as servers, desktop personal computers, kiosks, or tabletop devices. Additionally, the computing device 102 can represent a group of processing units or other computing devices.

In some examples, the computing device 102 has at least one processor 106 and a memory 108. The computing device 102 in other examples includes a user interface device 110.

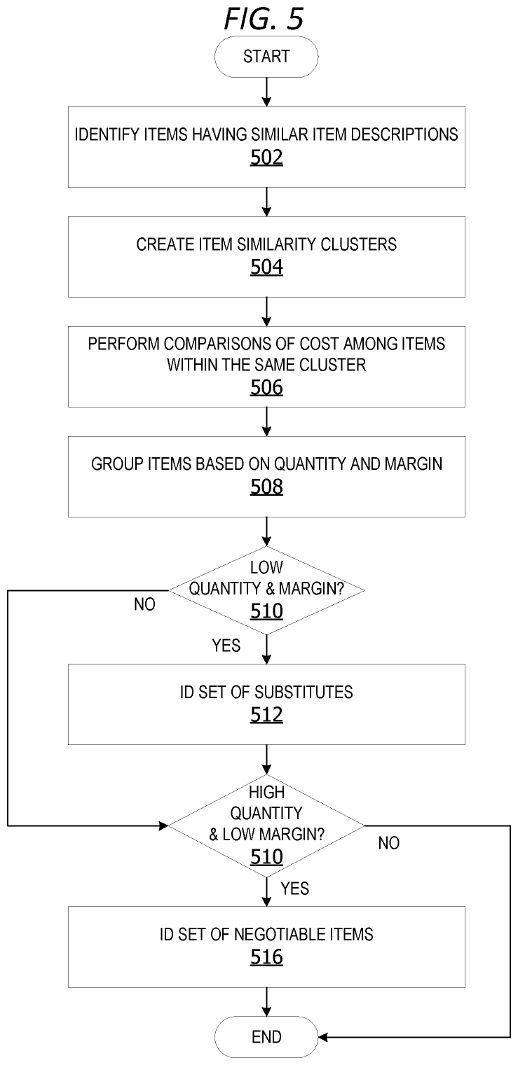

The processor 106 includes any quantity of processing units and is programmed to execute the computer-executable instructions 104. The computer-executable instructions 104 is performed by the processor 106, performed by multiple processors within the computing device 102 or performed by a processor external to the computing device 102. In some examples, the processor 106 is programmed to execute instructions such as those illustrated in the figures (e.g., FIG. 4 and FIG. 5).

The computing device 102 further has one or more computer-readable media such as the memory 108. The memory 108 includes any quantity of media associated with or accessible by the computing device 102. The memory 108 in these examples is internal to the computing device 102 (as shown in FIG. 1). In other examples, the memory 108 is external to the computing device (not shown) or both (not shown). The memory 108 can include read-only memory and/or memory wired into an analog computing device.

The memory 108 stores data, such as one or more applications. The applications, when executed by the processor 106, operate to perform functionality on the computing device 102. The applications can communicate with counterpart applications or services such as web services accessible via a network 112. In an example, the applications represent downloaded client-side applications that correspond to server-side services executing in a cloud.

In other examples, the user interface device 110 includes a graphics card for displaying data to the user and receiving data from the user. The user interface device 110 can also include computer-executable instructions (e.g., a driver) for operating the graphics card. Further, the user interface device 110 can include a display (e.g., a touch screen display or natural user interface) and/or computer-executable instructions (e.g., a driver) for operating the display. The user interface device 110 can also include one or more of the following to provide data to the user or receive data from the user: speakers, a sound card, a camera, a microphone, a vibration motor, one or more accelerometers, a BLUETOOTH® brand communication module, global positioning system (GPS) hardware, and a photoreceptive light sensor. In a non-limiting example, the user inputs commands or manipulates data by moving the computing device 102 in one or more ways.

The network 112 is implemented by one or more physical network components, such as, but without limitation, routers, switches, network interface cards (NICs), and other network devices. The network 112 is any type of network for enabling communications with remote computing devices, such as, but not limited to, a local area network (LAN), a subnet, a wide area network (WAN), a wireless (Wi-Fi) network, or any other type of network. In this example, the network 112 is a WAN, such as the Internet. However, in other examples, the network 112 is a local or private LAN.

In some examples, the system 100 optionally includes a communications interface component 114. The communications interface component 114 includes a network interface card and/or computer-executable instructions (e.g., a driver) for operating the network interface card. Communication between the computing device 102 and other devices, such as but not limited to the user device 116 and/or the cloud server 118, can occur using any protocol or mechanism over any wired or wireless connection. In some examples, the communications interface component 114 is operable with short range communication technologies such as by using near-field communication (NFC) tags.

The user device 116 represents any device executing computer-executable instructions. The user device 116 can be implemented as a mobile computing device, such as, but not limited to, a wearable computing device, a mobile telephone, laptop, tablet, computing pad, netbook, gaming device, and/or any other portable device. The user device 116 includes at least one processor and a memory. The user device 116 can also include a user interface device.

The cloud server 118 is a logical server providing services to the computing device 102 or other clients, such as, but not limited to, the user device 116. The cloud server 118 is hosted and/or delivered via the network 112. In some non-limiting examples, the cloud server 118 is associated with one or more physical servers in one or more data centers. In other examples, the cloud server 118 is associated with a distributed network of servers.

The system 100 can optionally include a data storage device 120 for storing data, such as, but not limited to, retail price change 122 for an item over time, cost trend 124 for an item over time and/or a set of negotiable items 126. The set of negotiable items is a set of one or more negotiable items. A negotiable item is an item having potential for reduced cost, increased margin and/or increased demand (sales volume) for the item in the future which can be accomplished via recommended negotiations with a supplier, selection of a different supplier, promotional price adjustments and/or replacement of the item with a substitute or alternative item.

The margin in some examples refers to the amount by which revenue exceeds cost (profit margin). In other words, margin refers to the difference between the cost to obtain the item and the amount received from sale of the same item.

Retail price of an item can change constantly over time based on the demand for the item, competitor pricing, promotions, seasonal discounts and various other factors. Price change of an item for rollback is typically set centrally and applied across all items within certain departments. Clearance/promotions and price adjustments are frequently made by store management when items are out-of-season or remain on the shelf for a threshold time-period. These items are tagged with certain report codes for different types of promotions along with the quantity of units sold at the offered promotional price.

The data storage device 120 can include one or more different types of data storage devices, such as, for example, one or more rotating disks drives, one or more solid state drives (SSDs), and/or any other type of data storage device. The data storage device 120, in some non-limiting examples, [includes a redundant array of independent disks (RAID) array. In other examples, the data storage device 120 includes a database.

The data storage device 120 in this example is included within the computing device 102 or associated with the computing device 102. In other examples, the data storage device 120 includes a remote data storage accessed by the computing device via the network 112, such as a remote data storage device, a data storage in a remote data center, or a cloud storage.

The memory 108 in some examples stores one or more computer-executable components. Exemplary components include a cost manager component 128. The cost manager component 128 compares item cost 132 for each item within item similarity clusters 130 to identify the set of negotiable items and/or substitute items for products showing both low sales and low margin.

In some examples, the cost manager component 128 provides cost negotiation guidance for different items using a negotiation lever based on retail price-based cost reverse engineering. Retail price of any item consists of promotional and/or non-promotional sales. For performing cost negotiations, the cost manager component identifies the trend of regular retail price of an item over time which is obtained after removing all the promotional events. The cost manager component 128 can compute the regular retail price of an item by removing different promotional effects like clearance, rollback, price adjustments etc.

By identifying the trend of change in regular retail price, the cost manager component 128 can determine if there is an opportunity for cost negotiations by comparing retail price trends with the trend of average unit cost for each item (per-unit basis) using correlation coefficient-based metric.

In some examples, the cost manager component uses item report codes to separate regular sales and then calculate Regular Average Unit Retail (AUR), which is the sell price of unit quantity. The cost manager component compares the change in trend of the regular AUR with the trend in the Average Unit Cost (AUC) for more efficient negotiation of the item cost.

These comparisons can also be performed by comparing the trends among similar item description clusters. These item similarity clusters are obtained by leveraging a combination of Lucene elastic search implementation and community detection algorithm.

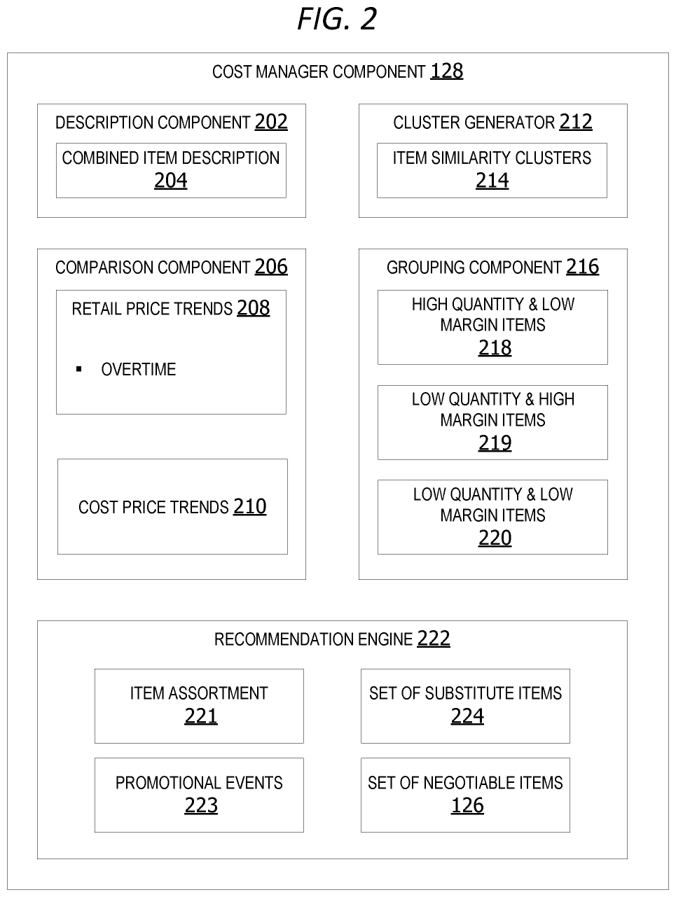

FIG. 2 is an exemplary block diagram illustrating a cost manager component 128. A description component 202 in some examples generates a combined item description 204 for each item in a set of one or more items. The combined item description 204 can be created based on product descriptions, ingredient lists, universal product code (UPC) for each item, and/or any other item description data.

A cluster generator 212 generates one or more item similarity clusters 214 for the plurality of items based on the combined item description 204 for each item in the plurality of items. The item similarity clusters 214 group items having the same or similar item descriptions. In some examples, the item description for an item includes relevant information of the same including its textual details, category, subcategory, fine-line information, color, texture, brand, size/quantity, etc.

A comparison component 206 in some examples compares retail price trends 208 of an item over time with cost price trends 210. The comparison component 206 compares costs of items within the same item similarity cluster.

A grouping component 216, in some examples, identifies high quantity sales and low margin items 218. These items are items which have high volume (high quantity) sales and a low profit margin.

The grouping component 216, in other non-limiting examples, identifies low quantity sales and high margin items 219. These items are items which have low volume sales (fewer units sold) and a high margin of profit.

The grouping component 216 in yet other examples identifies low quantity and low margin items 220. These items are items having both low volume sales (few sold) and low profit margins. In some cases, the system identifies one or more substitutes to replace the low volume and low margin items. The recommended substitutes are items which may have higher quantity sold and/or provide a higher margin than the item in the current assortment.

The recommendation engine 222 generates a set of substitute items 224 suitable to replace low quantity and low margin items 220 in an item assortment 221. An item assortment 121 is an assortment of items (products) associated with a store inventory and/or warehouse inventory. The item assortment can include types of products, sizes of products, varieties of products, brands, etc. The item assortment can include a current assortment or a planned/proposed assortment. A current assortment of items includes the physical inventory on store shelves, the current set of items in inventory, items on order and/or actual assortments of items associated with a retail environment (store) or warehouse. A proposed assortment includes a set of proposed or planned items which have not yet been ordered or implemented.

The recommendation engine 222 in other examples can also generate a set of negotiable items 126 from the group of high quantity and low margin items 218 which may benefit from additional cost negotiations to improve margin values for the items. For example, if the cost of obtaining the high quantity and low margin item can be lowered, the margin would increase.

In another example, the system identifies low quantity and high margin items. In this example, the recommendation engine 222 outputs a recommended action to increase sales volume. The recommended action can be output via an output device, such as, but not limited to, a user interface device, a display screen, a speaker, a printer or any other type of memory device.

The recommended action can include, without limitation, a promotional event 223 to increase quantity (sales volume) of the item sold. A promotional event can include, without limitation, a temporary price reduction, discount, a coupon, rebate, additional reward points, display modifications, marketing, additional signage, or other incentives for purchasing or trying the item.

Display modifications can include moving a display for the item to an end-cap display, an aisle display, a taller display, dedicated shelving for the item, or otherwise more visible display space. The display modifications make the item more visible to increase quantity of the item sold. Additional signage, including electronic signage as well as traditional non-electronic signage, can improve visibility and/or awareness of the item to increase quantity values for the item.

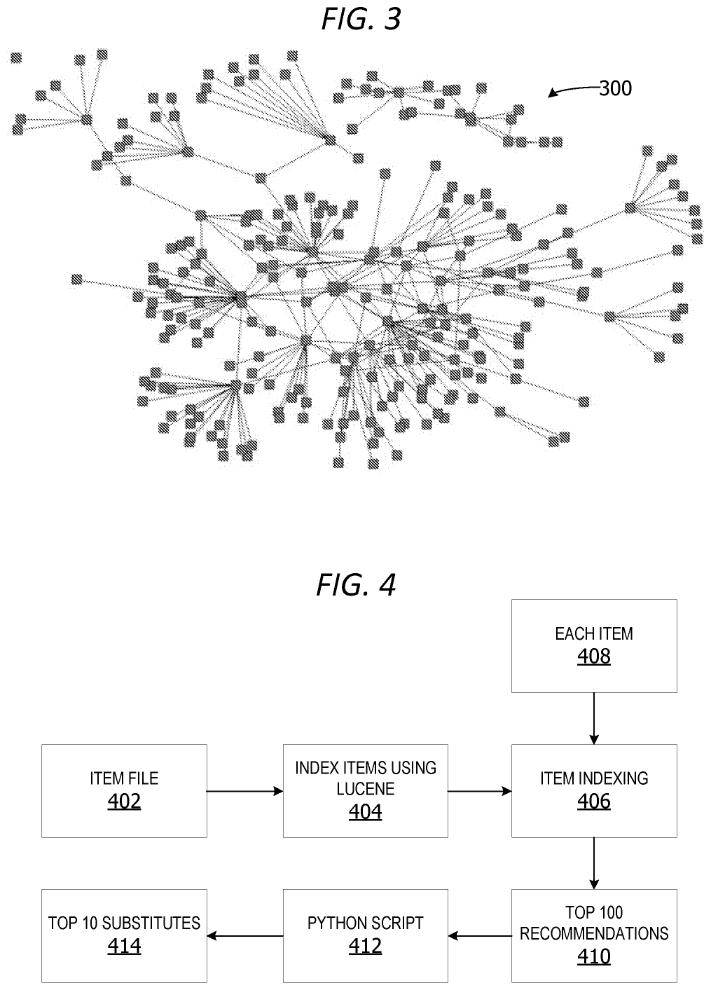

FIG. 3 is an exemplary block diagram illustrating a set of item similarity clusters. Comparison of average unit cost (AUC) is performed across different items within the same similarity item cluster to aid cost negotiation. The cost manager component identifies items with similar descriptions and creates clusters, so that it can perform comparison of AUC (average cost per-unit) among the items within the same cluster. Also, these clusters can be leveraged for additional cost negotiation opportunities such as join buy, dis-intermediation and parent-supplier connection.

FIG. 4 is an exemplary block diagram illustrating flow for computing similar cluster items. For creation of item similarity clusters, the cost manager component obtains similar description-based items. It can be computationally expensive to find similarity scores between all the possible item pairs.

To compute the pairwise item similarity, the cost manger component extracts various natural language-based features including n-grams, percentage match, words share and/or other data from an item file at 402 associated with each item 408. The metrics thus formed are used to compute various similarity scores like Jaccard index, Cosine similarity, etc. The weighted average of the similarity scores gives the separation between the two items, which is an indication of item substitutability.

The cost manger component indexes items using Lucene search library at 404. To make the number of item pairs for computing similarity metrics, cost manger component utilizes a Lucene search library, which is an inverted full-text index.

The cost manger component creates an item indexing at 406. The cost manager component takes all the documents, splits them into words and then builds an index for each word. The cost manger component utilizes the item descriptions like signage, UPC, supplier inputs, and/or other item description data to create the index for the items. Lucene library is utilized for building the index on the concatenated descriptions of the item. Once the index is built, the cost manger component parses each item through the index to obtain the top items recommended for additional action.

In some examples, the cost manger component identifies the top one-hundred (100) item recommendations (most relevant similar items). In other examples, the cost manger component identifies the top fifty (50) most relevant similar items based on their descriptions. The resultant set would be up to fifty most relevant items for each such item that has been parsed based on the similarity score computed by Lucene. This process continues for all the items that have been considered. The output is in the form of similar item pairs with their scores.

The similar item pairs obtained using the Lucene search functionality can be visualized in the form of a network, such as the item similarity clusters shown in FIG. 3. Each item resembles a node and every item pair resembles an edge connecting the nodes as shown in FIG. 3 above. The scores between each item pair is utilized as edge weight in a graph. The cost manager component identifies communities of similar items among these item pairs. There are numerous algorithms to achieve this. In some examples, the cost manager component utilizes an algorithm which can follow a top-down approach.

Edge-betweenness-community is a hierarchical decomposition method utilized by the cost manger component in some examples where edges are removed in the decreasing order of their edge betweenness. This is done assuming that edges connecting different groups mostly contain multiple shortest paths. It yields good results but is slow since its computation intensive due to calculations of edge betweenness. Also, they can be re-calculated after every edge removal. Its ideal for few thousands of vertices in the data. It builds a full dendrogram and does not give the final cut off point to obtain the final groups.

In other examples, a fast greedy-community hierarchical approach is used. This is a bottom-up instead of top-down. Modularity gets optimized in a greedy manner. Communities are merged iteratively considering every vertex belongs to a different community so that each merge is locally optimal. The algorithm stops when modularity has reached its saturation. The method is fast and hence most sorted as there are no parameters that needs to be fine-tuned. One drawback is that communities below a given size gets merged with neighboring communities.

Walk trap-community can be utilized in still other examples. The walk-trap community performs random walks on the network. These walks tend to stay within the same group because there would be few edges that lead to outside group. Walk trap runs short random walks of 3-5 steps and results are used to merge separate communities in a bottom-up fashion. Modularity score can be leveraged to select where to cut the dendrogram. It is a bit slower than the fast-greedy approach but is more accurate.

Spinglass-community is from statistical physics based on Potts model in yet other examples. Each vertex of the network can be in one of c spin states, and the edges of the specify which pairs of vertices would prefer to stay in the same spin state. Communities get defined after simulating for a given number of steps based on the spin states of the vertices in the network. This method is not fast and not deterministic due to the inherent simulation but has a tunable parameter to determine the cluster size.

In some examples, leading-eigenvector-community is a top-down hierarchical method which optimizes the modularity function. At each iteration the network is split into two parts such that the separation yields a significant increase in modularity. Split is determined by evaluating leading eigenvector of modularity matrix. Due to the eigenvector calculations, it might not work on degenerate networks.

Label-propagation-community in other examples is a simple method where every node is assigned one of k labels. During different iterations it re-assigns labels to nodes in a way that each node takes the most frequent label of its neighbors. The method stops when the label of each node is one of the most frequent labels in its neighborhood. It is very fast but yields different results based on the initial seeds. Hence, one should run the algorithm a large number of times and then build the final communities which is tedious.

The cost manger component in other examples utilizes customized constraint-based Louvain community detection algorithm to determine the optimal clusters. This algorithm also optimizes modularity which is a scale value between −1 and 1 that measures the density of edges inside communities to edges outside communities. First small communities are identified by optimizing modularity locally on all nodes, then they are grouped into one node for the next iteration. The modularity is calculated as follows:

$$Q = \frac{1}{2 m} {\sum }_{ij} [ {A}_{ij} - \frac{{k}_{i} {k}_{j}}{2 m} ] δ ( {c}_{i} , {c}_{j} ) ,$$

where, Aᵢⱼ represents the edge weight between nodes i and j. In this example, kᵢ and kⱼ are sum of weights of the edges attached to nodes i and j. The term 2m is the sum of edge weights in the graph. The terms cᵢ and cⱼ are communities of the nodes. Likewise, δ is a delta function.

The modularity has been maximized using constrained optimization on the UPC information.

The cost manager component identifies a degree of granularity of the communities. For solving this problem, the cost manager component leverages item UPC information. The same UPC might be supplied by different suppliers and have different item numbers. Since we are grouping different item numbers under the communities, the UPC information helps us to determine if the communities have been formed correctly. The system ensures that most of the communities that have been formed contains all the items of the same UPC number falling into the same community. If this fails for 90% of the items then the algorithm is re-run by fine tuning the edges and breaking the communities further to achieve the above constraint.

On removing weak edges from the network, the Louvain algorithm creates more granular clusters leading for most of the items having same UPC to fall into the same community. Several iterations are performed and under each iteration a new network is created with the fine-tuned edges and the communities are identified ensuring that 90% of the items having same UPC fall into the same community.

FIG. 5 is an exemplary flow chart illustrating operation of the computing device to identify negotiable items and item substitutes. The process shown in FIG. 5 is performed by a cost manager component, executing on a computing device, such as the computing device 102 or the user device 116 in FIG. 1.

The process begins by identifying items having similar item descriptions at 502. The cost manager component creates a set of item similarity clusters at 504. The cost manager component performs comparisons of cost among items within the same cluster at 506. The cost manager component groups item based on quantity and margin for each item at 508. The cost manager component determines if any items are classified as low quantity and low margin items at 510. If yes, the cost manager component identifies a set of substitutes at 512. The cost manager component determines if any of the items are high quantity and low margin items at 514. If yes, the cost manager component identifies a set of negotiable items at 516 associated with the high quantity and low margin items. The process terminates thereafter.

While the operations illustrated in FIG. 5 are performed by a computing device, aspects of the disclosure contemplate performance of the operations by other entities. In a non-limiting example, a cloud service performs one or more of the operations.

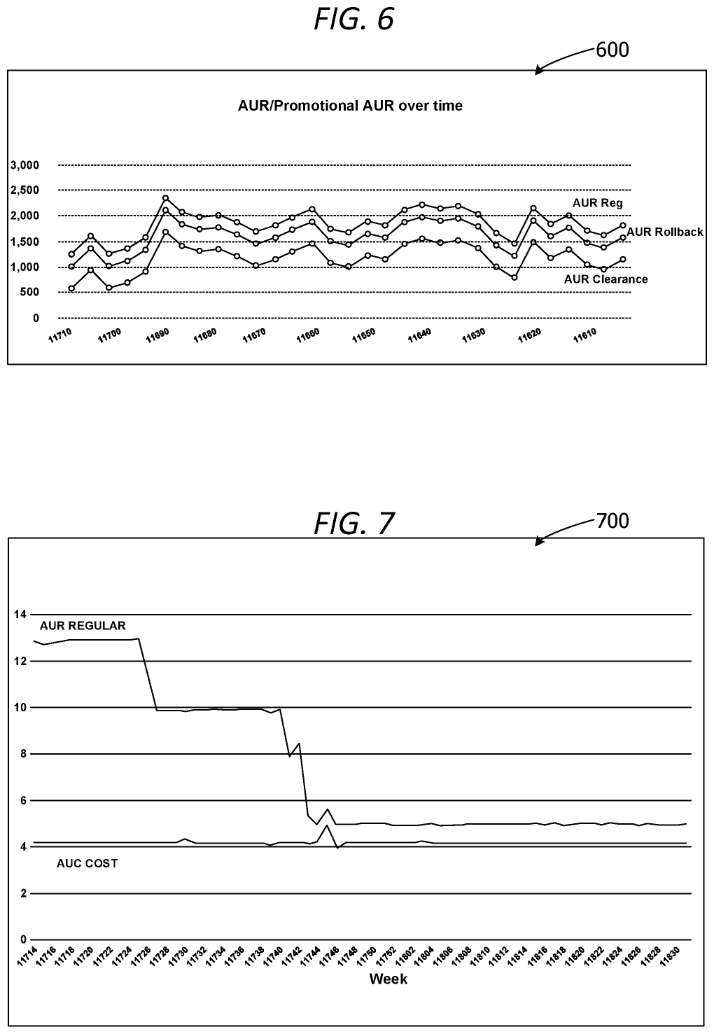

FIG. 6 is an exemplary graph 600 illustrating promotional breakdown of retail item price. Regular retail price of an item refers to non-promotional price of the item over time. In some examples, the cost manager component builds out data at a per-week level in order to avoid day-level nuances in the data. This also avoids data sparsity for low selling items.

In some examples, the cost manager component averages the prices of different items across different stores/retail locations. This enables the cost manager component to generalize the retail and cost data trend over time and across stores/locations. The cost manager component computes actual sales/units across different weeks.

In other examples, the cost manager component flags different promotional events based on the item report codes from the item description data to identify the promotional contribution of various events associated with item sales and units. Regular sales and units can be computed using the following formula:

Regular Sales=Actual Sales−Rollback Sales−Clearance Sales−Price Adjustment Sales; and

Regular Units=Actual Units−Rollback Units−Clearance Units−Price Adjustment Units.

Regular AUR can be computed as a ratio of Regular Sales and Regular units over different weeks. Similarly, AUC can be computed as a ratio of Net ship cost to the Net ship quantity over different weeks.

On computation of AUR and AUC separating out the promotional effects, the trend of the variables is compared using Pearson ̆s correlation coefficient ratio metric, shown below as follows:

r_ratio=(r_{AUR,time})/(r_{AUR,time}+ε) where,

r_ratio—correlation coefficient ratio metric;

r_{AUR,time}—correlation coefficient of AUR over time; and

r_{AUR,time}—correlation coefficient of AUC over time.

FIG. 7 is an exemplary graph 700 illustrating trend-based analysis of AUC and AUR. As shown in FIG. 7, the AUR retail price for the selected item decreased with time whereas the unit cost price remains almost constant giving an indication for potential negotiation.

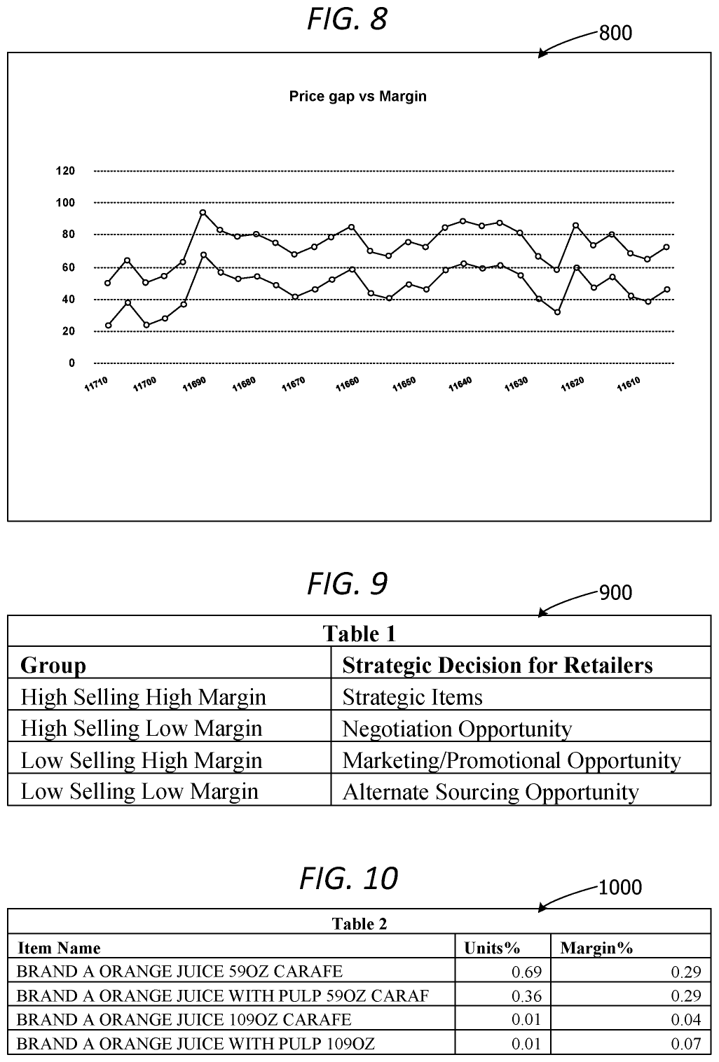

FIG. 8 is an exemplary graph 800 illustrating price gap versus margin. As the price gap increases the per-item margin corresponding increases. Likewise, a decrease in price gap is associated with a decrease in margin.

FIG. 9 is an exemplary table 900 illustrating quantity and margin item groups. Once communities are identified, all the items are tagged to each of the communities. The cost manager component computes the volume and margin percent for each of the item. Items in each of the clusters are grouped/classified into one of four groups/categories based on the distribution volume (quantity) and margin percent. The group classification for each item assists the user in determining whether to take action with regard to an item. The action can include negotiating for lower costs and/or identifying substitute items. This assist the user in making a strategic decision for improved quality and sales as shown in table 900.

FIG. 10 is an exemplary table 1000 illustrating item margin percentage. Retail-based cost negotiations can be performed within each item similarity cluster that has been formed. In table 1000, there are four similar items in the same cluster. The table shows a good margin percent and good volume percent for the first two items in comparison with the bottom two items. Customers tend to buy smaller packs rather than the larger packs in this variety of items. The cost manager component can output a recommendation to improve the profits by procuring increased quantities of first two items as they have been liked by the customers and they have been having maximum margin percentage as shown in table 1000.

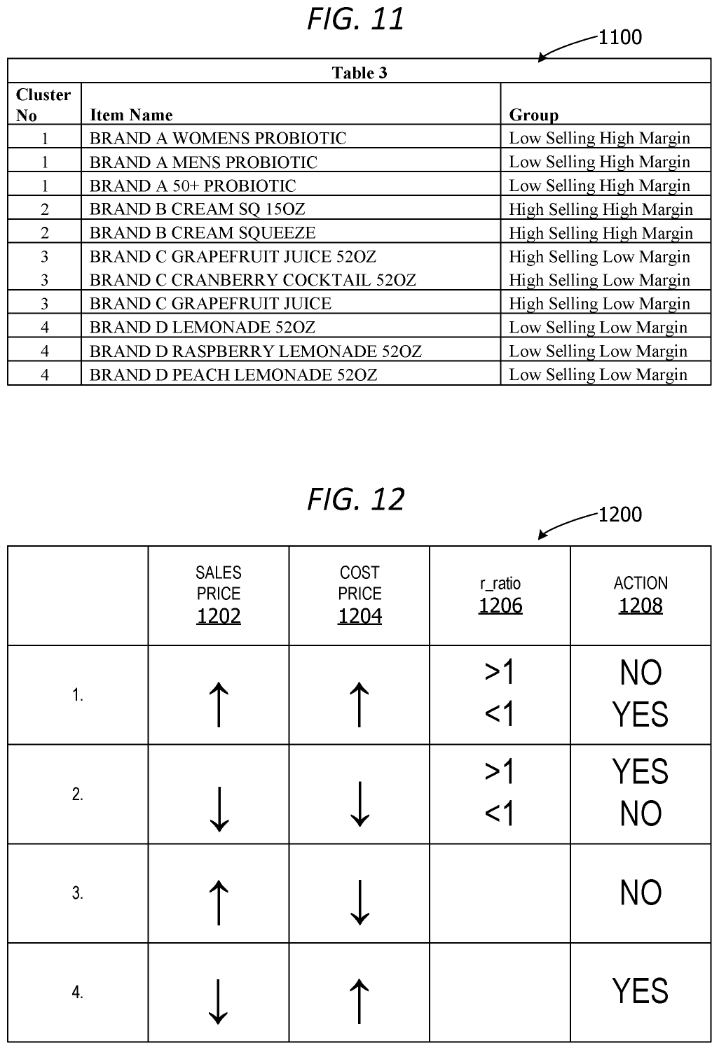

FIG. 11 is an exemplary table 1100 illustrating per-cluster item groupings. The item similarity clusters that have been formed can be classified to one of the groups as shown in the table 1100. Each group can the cost manager component and/or a user make a strategic decision to increase customer satisfaction, increased sales and/or improve traffic/number of customers to the store.

FIG. 12 is an exemplary table 1200 illustrating a set of recommended actions based on per-item cost trends. The correlation coefficient gives an adept understanding of the variation of the one of the variables with respect to another and hence in this case it has proven to be efficient in detecting negotiable items efficiently. The entire scenario can be broken down into the four scenarios shown in FIG. 12.

In the first example, where both item sale price and cost price are increasing while the r_ratio is greater than one, no action is needed. If the r_ratio is less than one, there is scope for negotiation. In other words, the item is flagged as an item which can be benefited by additional price/cost negotiation.

In the second non-limiting example, if the sale price and the cost price are both decreasing while the r_ratio is greater than one, cost negotiations are recommended for the item. If the r_ratio is less than one, no action is recommended.

In the third example, if sale price is increasing and cost price is decreasing, no action is required. If the sale price is decreasing and the cost price is increasing, then action is recommended to either assist with increasing the sale price, decreasing the cost price or otherwise replacing the item with a suitable substitute (equivalent) item in the item assortment.

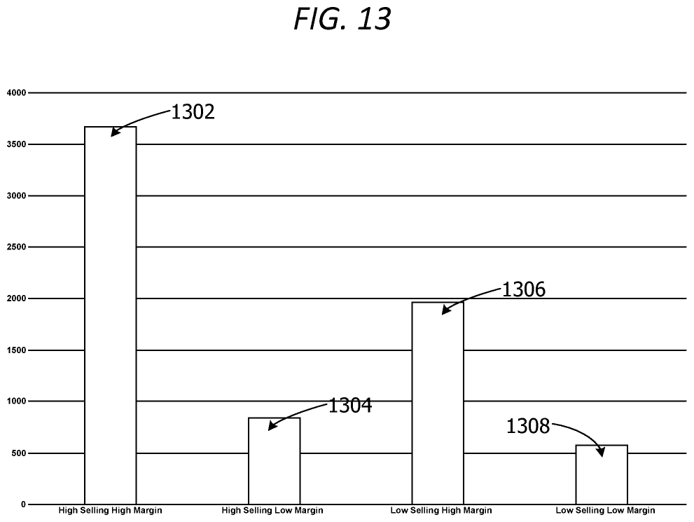

FIG. 13 is an exemplary bar graph 1300 illustrating quantity and margin values for an item. In this example, the item(s) at 1302 shows high quantity and high margin. The item(s) at 1304 shoes high selling and low margin. The item(s) at 1306 show low quantity and high margin. The item(s) at 1308 show low quantity and low margin.

### ADDITIONAL EXAMPLES

In some examples, the system compares similar cost-comparable items within the same item similarity clusters to identify products which have sales volume (quantity) and/or profit margin below an average quantity and average margin for other cost-comparable products in the same cluster. These underperforming products are identified as negotiable items. If a product has a below average quantity (sales volume), the system recommends promotional activities to improve quantity and/or replacement of the product in the item assortment with a better performing substitute (equivalent) product. If the identified product has below average profit margin, the system recommends negotiations with the supplier to reduce cost or replacement of the product with a better performing equivalent product in the item assortment for the store.

The system can recommend many different actions to improve quantity (volume) of a product. In some non-limiting examples, the system recommends moving an item display to an end-cap display or other more visible location within a store. Increasing product visibility can improve sales. In other examples, a promotion may be offered for the product to reduce price. The price reduction or other incentives can improve sales volume.

In other non-limiting examples, if a product has below average margin, the system identifies negation levers for negotiations with a supplier to reduce costs associated with the product. Reduced costs can improve/increase margin. In other examples, the system identifies similar/equivalent products having higher margins which can be used to replace the product in the product assortment. In other words, the store ceases to carry the underperforming produce and instead stocks an equivalent product having a higher margin (lower cost) associated with it.

In still other examples, the system detects negotiable items and determines how cost negotiations can be performed by leveraging retail price-based cost reverse engineering negotiation methods. In other examples, retail price change of an item over time is analyzed along with the cost trend of the item to determine potential for cost negotiations. These comparisons are performed within different item similarity clusters to determine how different peer items within the same similarity cluster perform with respect to retail price and cost price trends. The system efficiently captures and detects the most robust set of negotiable items considering major attributes including margin percent, sales volume, substitutability etc.

In an example scenario, the system utilizes community detection and elastic search for detection of similar items based on their descriptions. Both of these together are leveraged for cost negotiations. The system utilizes items details like descriptions, signage etc. for identifying item similarity clusters. Along with these descriptions, retail price, promotional activities, cost information, warehouse data, external data like holidays, events, and/or climatic conditions are analyzed for obtaining the regular retail trend and cost price trends for different items across departments.

The system in other examples analyzes average unit retail and comparing with the average unit cost to identify cost negotiation possibilities in one dimension. On identification of item similarity clusters and comparing AUC with AUR across different items within the same item similarity cluster for leveraging cost negotiation opportunities in multiple dimensions, since item cost performance across different items is being compared. Tagging of each item into different groups in terms of their selling and margin performance helps the sourcing managers/users to better negotiate with different suppliers across the globe and make decisions associated with promotions, display locations, signage, pricing, product assortments and/or other product sales incentives.

In one non-limiting example, managers/users obtain identification of low quantity and/or low margin products within a product assortment, where the low quantity and low margin products are determined based on average quantity and average margin for the same/similar (equivalent) products within an item similarity cluster. The managers/users then initiate an action to increase the quantity or increase the margin for those identified low-performing products. The actions can include removing the low-performing product from the product assortment and replacing it with a better performing substitute/equivalent product, providing an incentive or other promotional offer, reducing product price, moving the store display where the product is displayed to a more favorable/visible location, negotiating with suppliers and/or others in the supply chain to reduce costs, tie a promotional offer for a higher volume product to the underperforming product, or otherwise take an action to increase the quantity and/or margin of the identified items.

Alternatively, or in addition to the other examples described herein, examples include any combination of the following:
a low quantity and low margin group in a set of groupings, wherein the recommendation component outputs a set of substitute item recommendations to replace each item in the low quantity and low margin group;
a low quantity and high margin group in a set of groupings, wherein the recommendation component outputs a recommended promotional event for each item in the low quantity and high margin group;
a high quantity and low margin group in a set of groupings, wherein the recommendation component outputs a set of negotiable items recommendations for each item in the high quantity and low margin group;
a recommended set of promotional events associated with at least one item in a high quantity and low margin item grouping;
a recommended set of substitute items suitable to replace at least one low quantity and low margin item in an item assortment;
a cost manager component, implemented on the at least one processor, compares retail price trends associated with a set of items with the trend of average unit cost for each item in the set of items using correlation coefficient-based metric to identify at least one negotiable item in the set of items;
the comparison component compares average unit cost on a per-unit basis across different items within the same similarity item cluster to identify a set of negotiable items;
an item similarity score for each item within the same item similarity cluster, wherein a cost manger component extracts natural language-based features from an item file associated with each item in the same item similarity cluster;
an item index, wherein a cost manager component utilizes a Lucene library for building the item index based on concatenated descriptions of at least one item in an item similarity cluster;
analyzing, by a description component, item description data to generate a combined item description for each item in a set of items;
creating, by a cluster generator, a set of item similarity clusters associated with the set of items;
comparing, by a comparison component, cost between a set of items within a selected item similarity cluster in the set of item similarity clusters;
grouping, by a grouping component, items in the set of items based on quantity and margin values associated with each item;
outputting, via an output device, a recommended action associated with each item in the set of items based on the grouping of each item, wherein the recommended action comprising negotiation or substitution of at least one item;
generating a low quantity and low margin group in a set of groupings;
outputting a set of substitute item recommendations to replace each item in the low quantity and low margin group;
generating a low quantity and high margin group in a set of groupings;
outputting a recommended promotional event for each item in the high quantity and low margin group;
generating a high quantity and low margin group in a set of groupings;
outputting a set of negotiable items recommendations for each item in the high quantity and low margin group;
comparing retail price trends associated with a set of items with the trend of average unit cost for each item in the set of items using correlation coefficient-based metric to identify at least one negotiable item in the set of items;
comparing average unit cost on a per-unit basis across different items within the same similarity item cluster to identify a set of negotiable items;
One or more computer storage devices, having computer-executable instructions for performing cost comparisons within item similarity clusters by a cost comparison component, that, when executed by a computer cause the computer to perform operations comprising creating a set of item similarity clusters associated with the set of items based on a combined item description for each item in a set of items associated with an item assortment; comparing cost between a set of items within a selected item similarity cluster in the set of item similarity clusters; grouping items in the set of items based on quantity and margin values associated with each item; and outputting, via an output device, a recommended action associated with each item in the set of items based on the grouping of each item;
wherein the cost comparison component, when further executed by a computer, cause the computer to perform operations comprising generating a low quantity and low margin group in a set of groupings; and outputting a set of substitute item recommendations to replace each item in the low quantity and low margin group;
wherein the cost comparison component, when further executed by a computer, cause the computer to perform operations comprising generating a low quantity and high margin group in a set of groupings; and outputting a recommended promotional event for each item in the high quantity and low margin group; and
wherein the cost comparison component, when further executed by a computer, cause the computer to perform operations comprising generating a high quantity and low margin group in a set of groupings; and outputting a set of negotiable items recommendations for each item in the high quantity and low margin group.

At least a portion of the functionality of the various elements in FIG. 1, FIG. 2, FIG. 3 and FIG. 4 can be performed by other elements in FIG. 1, FIG. 2, FIG. 3 and FIG. 4, or an entity (e.g., processor 106, web service, server, application program, computing device, etc.) not shown in FIG. 1, FIG. 2, FIG. 3 and FIG. 4.

In some examples, the operations illustrated in FIG. 4 and FIG. 5 can be implemented as software instructions encoded on a computer-readable medium, in hardware programmed or designed to perform the operations, or both. For example, aspects of the disclosure can be implemented as a system on a chip or other circuitry including a plurality of interconnected, electrically conductive elements.

In other examples, a computer readable medium having instructions recorded thereon which when executed by a computer device cause the computer device to cooperate in performing a method of performing cost comparisons using item similarity clusters, the method comprising analysing item description data to generate a combined item description for each item in a set of items; creating a set of item similarity clusters associated with the set of items; comparing cost among items within a selected item similarity cluster in the set of item similarity clusters; grouping items in the set of items based on quantity and margin values associated with each item; and generating a recommended action associated with each item in the set of items based on the grouping of each item.

While the aspects of the disclosure have been described in terms of various examples with their associated operations, a person skilled in the art would appreciate that a combination of operations from any number of different examples is also within scope of the aspects of the disclosure.

The term ‘Wi-Fi_ as used herein refers, in some examples, to a wireless local area network using high frequency radio signals for the transmission of data. The term ‘BLUETOOTH®_ as used herein refers, in some examples, to a wireless technology standard for exchanging data over short distances using short wavelength radio transmission. The term ‘NFC_ as used herein refers, in some examples, to a short-range high frequency wireless communication technology for the exchange of data over short distances.

While no personally identifiable information is tracked by aspects of the disclosure, examples have been described with reference to data monitored and/or collected from the users. In some examples, notice is provided to the users of the collection of the data (e.g., via a dialog box or preference setting) and users are given the opportunity to give or deny consent for the monitoring and/or collection. The consent can take the form of opt-in consent or opt-out consent.

### Exemplary Operating Environment

Exemplary computer-readable media include flash memory drives, digital versatile discs (DVDs), compact discs (CDs), floppy disks, and tape cassettes. By way of example and not limitation, computer-readable media comprise computer storage media and communication media. Computer storage media include volatile and nonvolatile, removable and non-removable media implemented in any method or technology for storage of information such as computer-readable instructions, data structures, program modules and the like. Computer storage media are tangible and mutually exclusive to communication media. Computer storage media are implemented in hardware and exclude carrier waves and propagated signals. Computer storage media for purposes of this disclosure are not signals per se. Exemplary computer storage media include hard disks, flash drives, and other solid-state memory. In contrast, communication media typically embody computer-readable instructions, data structures, program modules, or the like, in a modulated data signal such as a carrier wave or other transport mechanism and include any information delivery media.

Although described in connection with an exemplary computing system environment, examples of the disclosure are capable of implementation with numerous other general purpose or special purpose computing system environments, configurations, or devices.

Examples of well-known computing systems, environments, and/or configurations that can be suitable for use with aspects of the disclosure include, but are not limited to, mobile computing devices, personal computers, server computers, hand-held or laptop devices, multiprocessor systems, gaming consoles, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, and the like. Such systems or devices can accept input from the user in any way, including from input devices such as a keyboard or pointing device, via gesture input, proximity input (such as by hovering), and/or via voice input.

Examples of the disclosure can be described in the general context of computer-executable instructions, such as program modules, executed by one or more computers or other devices in software, firmware, hardware, or a combination thereof. The computer-executable instructions can be organized into one or more computer-executable components or modules. Generally, program modules include, but are not limited to, routines, programs, objects, components, and data structures that perform tasks or implement abstract data types. Aspects of the disclosure can be implemented with any number and organization of such components or modules. For example, aspects of the disclosure are not limited to the specific computer-executable instructions or the specific components or modules illustrated in the figures and described herein. Other examples of the disclosure can include different computer-executable instructions or components having more functionality or less functionality than illustrated and described herein.

In examples involving a general-purpose computer, aspects of the disclosure transform the general-purpose computer into a special-purpose computing device when configured to execute the instructions described herein.

The examples illustrated and described herein as well as examples not specifically described herein but within the scope of aspects of the disclosure constitute exemplary means for analyzing item cost data within item similarity clusters to identify negotiable items and substitute items. For example, the elements illustrated in FIG. 1, FIG. 2, FIG. 3 and FIG. 4, such as when encoded to perform the operations illustrated in FIG. 4 and FIG. 5, constitute exemplary means for analysing item description data to generate a combined item description for each item in a set of items; exemplary means for creating a set of item similarity clusters associated with the set of items; exemplary means for comparing cost among items within a selected item similarity cluster in the set of item similarity clusters; exemplary means for grouping items in the set of items based on quantity and margin values associated with each item; and exemplary means for outputting a recommended action associated with each item in the set of items based on the grouping of each item.

Other non-limiting examples provide one or more computer storage devices having a first computer-executable instructions stored thereon for providing item cost analysis using item similarity clusters. When executed by a computer, the computer performs operations including analysing item description data to generate a combined item description for each item in a set of items; creating a set of item similarity clusters associated with the set of items; comparing cost among items within a selected item similarity cluster in the set of item similarity clusters; grouping items in the set of items based on quantity and margin values associated with each item; and generating a recommended action associated with each item in the set of items based on the grouping of each item.

The order of execution or performance of the operations in examples of the disclosure illustrated and described herein is not essential, unless otherwise specified. That is, the operations can be performed in any order, unless otherwise specified, and examples of the disclosure can include additional or fewer operations than those disclosed herein. For example, it is contemplated that executing or performing an operation before, contemporaneously with, or after another operation is within the scope of aspects of the disclosure.

When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there can be additional elements other than the listed elements. The term ‘exemplary_ is intended to mean ‘an example of._ The phrase ‘one or more of the following: A, B, and C_ means ‘at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A system for performing cost comparisons within item similarity clusters, the system comprising:
a memory;
at least one processor communicatively coupled to the memory;
a data storage device comprising a database storing item description data;
a description component, implemented on the at least one processor, analyzes the item description data associated with items in a set of items in an item assortment to generate a combined item description for each item in the set of items;
a cluster generator, implemented on the at least one processor, creates a set of item similarity clusters associated with the set of items;
a comparison component, implemented on the at least one processor, compares cost among items within a selected item similarity cluster in the set of item similarity clusters;
a grouping component, implemented on the at least one processor, groups items in the set of items based on quantity and margin values associated with each item; and
a recommendation component, implemented on the at least one processor, outputs a recommended action associated with each item in the set of items via an output device, the recommended action is generated based on a grouping of each item, wherein the recommended action comprises negotiation associated with at least one item or substitution of the at least one item in the item assortment.

2. The system of claim 1, further comprising:
a low quantity and low margin group in a set of groupings, wherein the recommendation component outputs a set of substitute item recommendations to replace each item in the low quantity and low margin group.

3. The system of claim 1, further comprising:
a low quantity and high margin group in a set of groupings, wherein the recommendation component outputs a recommended promotional event for each item in the low quantity and high margin group.

4. The system of claim 1, further comprising:
a high quantity and low margin group in a set of groupings, wherein the recommendation component outputs a set of negotiable items recommendations for each item in the high quantity and low margin group.

5. The system of claim 1, further comprising:
a recommended set of promotional events associated with at least one item in a low quantity and high margin item grouping.

6. The system of claim 1, wherein the recommended action further comprises:
a recommended set of substitute items suitable to replace at least one low quantity and low margin item in the item assortment.

7. The system of claim 1, wherein the recommended action further comprises:
a cost manager component, implemented on the at least one processor, compares retail price trends associated with the set of items with a trend of average unit cost for each item in the set of items using correlation coefficient-based metric to identify at least one negotiable item in the set of items.

8. The system of claim 1, further comprising:
the comparison component compares average unit cost on a per-unit basis across different items within the same similarity item cluster to identify a set of negotiable items.

9. The system of claim 1, further comprising:
an item similarity score for each item within a same item similarity cluster, wherein a cost manger component extracts natural language-based features from an item file associated with each item in the same item similarity cluster.

10. The system of claim 1, further comprising:
an item index, wherein a cost manager component utilizes a library for building the item index based on concatenated descriptions of at least one item in the selected item similarity cluster.

11. A computer-implemented method for performing cost comparisons within item similarity clusters, the method comprising:
analyzing, by a description component, item description data to generate a combined item description for each item in a set of items;
creating, by a cluster generator, a set of item similarity clusters associated with the set of items;
comparing, by a comparison component, cost between the set of items within a selected item similarity cluster in the set of item similarity clusters;
grouping, by a grouping component, items in the set of items based on quantity and margin values associated with each item; and
outputting, via an output device, a recommended action associated with each item in the set of items based on the grouping of each item, wherein the recommended action comprising negotiation or substitution of at least one item.

12. The computer-implemented method of claim 11, further comprising:
generating a low quantity and low margin group in a set of groupings; and
outputting a set of substitute item recommendations to replace each item in the low quantity and low margin group.

13. The computer-implemented method of claim 11, further comprising:
generating a low quantity and high margin group in a set of groupings; and
outputting a recommended promotional event for each item in the high quantity and low margin group.

14. The computer-implemented method of claim 11, further comprising:
generating a high quantity and low margin group in a set of groupings; and
outputting a set of negotiable items recommendations for each item in the high quantity and low margin group.

15. The computer-implemented method of claim 11, further comprising:
comparing retail price trends associated with a set of items with a trend of average unit cost for each item in the set of items using correlation coefficient-based metric to identify at least one negotiable item in the set of items.

16. The computer-implemented method of claim 11, further comprising:
comparing average unit cost on a per-unit basis across different items within the same similarity item cluster to identify a set of negotiable items.

17. One or more computer storage devices, having computer-executable instructions for performing cost comparisons within item similarity clusters by a cost comparison component, that, when executed by a computer cause the computer to perform operations comprising:
creating a set of item similarity clusters associated with the set of items based on a combined item description for each item in the set of items associated with an item assortment;
comparing cost between a selected set of items within a selected item similarity cluster in the set of item similarity clusters;
grouping items in the selected set of items based on quantity and margin values associated with each item; and
outputting, via an output device, a recommended action associated with each item in the selected set of items based on the grouping of each item.

18. The one or more computer storage devices of claim 17, wherein the cost comparison component, when further executed by a computer, cause the computer to perform operations comprising:
generating a low quantity and low margin group in a set of groupings; and
outputting a set of substitute item recommendations to replace each item in the low quantity and low margin group.

19. The one or more computer storage devices of claim 17, wherein the cost comparison component, when further executed by a computer, cause the computer to perform operations comprising:
generating a low quantity and high margin group in a set of groupings; and
outputting a recommended promotional event for each item in the high quantity and low margin group.

20. The one or more computer storage devices of claim 17, wherein the cost comparison component, when further executed by a computer, cause the computer to perform operations comprising:
generating a high quantity and low margin group in a set of groupings; and
outputting a set of negotiable items recommendations for each item in the high quantity and low margin group.
